(19) United States
(12) Patent Application Publication
(10) Pub. No.: US 2015/0309203 A1
(43) Pub. Date: Oct. 29, 2015

(54) ELECTRONIC DRYWALL FASTENER LOCATER

(71) Applicant: Jeremy James Monroe, Ventura, CA (US)

(72) Inventor: Jeremy James Monroe, Ventura, CA (US)

(21) Appl. No.: 14/680,429

(22) Filed: Apr. 7, 2015

Related U.S. Application Data
(60) Provisional application No. 61/978,858, filed on Apr. 12, 2014.

(51) Int. Cl. G01V 3/10; G01V 3/15

(52) U.S. Cl. CPC G01V 3/101; G01V 3/15

(57) ABSTRACT

An electronic drywall fastener/stud locator that includes a plurality of metal detectors connected together, each having a shunt resistance that varies based on the size of surrounding metal objects and the proximity of these objects. A sensing circuit is coupled to the sensor plates to measure the resonant frequency of the sensor plates. A controller is coupled to the sensing circuit to analyze the resonant frequency and parallel reactance measured by the sensing circuit. One or a plurality of indicators are coupled to the controller and are selectively activated to identify the location of a relative high inductance, which can be indicative of a wooden or metallic stud behind a surface.

### REFERENCE TO PRIOR APPLICATION

This application, claims priority of the provisional patent application 61/978,858, filed Apr. 12, 2014 entitled ELECTRONIC DRYWALL FASTENER TOOL by Jeremy James Monroe.

### BACKGROUND OF THE INVENTION

1. Field of the Invention

The present invention relates to the field of devices for locating items behind solid matter and more particularly toward a device that can detect a drywall fastener behind a wall for determining the location of studs for hanging things on the wall.

2. Description of the Prior Art

There is often a need for one to secure a heavy item to something stable on one's wall, whether in a home or a commercial building. If one attempts to hang a heavy item to the sheetrock or drywall only, not secured to the interior wall stud, then this attachment method could be unstable and the item could fall.

There exists in the prior art two popular methods for locating a wall stud. One method is to use powerful rare earth magnetic detection. This method is accurate, but the magnets can be a danger to health and electronics. For example, strong magnets can introduce a severe pinching hazard. They are toxic if ingested. They can erase electronic hard drive and other electronic media. The scanning area of a powerful rare earth metal detection system is also limited by the size and power of the magnet.

The second method is electronic capacitive sensing. This method can be unreliable and cannot distinguish between different materials such as metal, wood or human skin. Accordingly, this method can easily produce false readings. For example, a plumbing pipe can show the same reading as a wood stud resulting the possibility that the user may unknowingly hammer a nail into the plumbing thereby causing damage to the home's interior walls and flooring.

It is the object of the present invention to provide an improved device that does not contain the limitations of the prior art.

It is a further object of the present invention to provide a means for reliably locating the interior wall stud, typically a 2″×4″ stud, by electronically sensing and indicating the location of the metallic drywall fastener, typically a nail or screw which fastens the sheet of drywall to the stud.

It is a further object of the present invention to provide a device and method that precisely locates sheetrock/drywall fasteners electronically and displays their location using LED indicators.

It is a further object of the present invention to provide a device and method that uses an array of small metal detectors that can only sense small metal drywall fasteners, nails or screws and will therefore not produce false readings. By adding more detectors to the device, or spreading them wider, the device's detection surface area can be extended. Because the sheetrock fastener will be accurately located, the device and method of the present invention accordingly accurately locates the wall stud where the drywall fastener attaches the sheet of drywall to the interior wall stud.

### SUMMARY OF THE INVENTION

The basic embodiment of the present invention teaches a handheld, portable metal fastener detector comprising: an outer casing having a top surface, a bordering perimeter surface, a gripping end and a sensing end wherein said top surface and bordering perimeter surface defined an enclosed space therein; a sensing PCB surface attached to said bordering perimeter surface thereby defining an enclosing bottom surface; a proximity sensing circuit inside said enclosed space of said outer casing located on said sensing end; a controller coupled to said proximity sensing circuit; a display circuit inside said enclosed space of said outer casing located on said sensing end wherein said display circuit is in communication with said proximity sensing circuit; a power source coupled to said controller and connected to said display circuit; an indicator display that displays said display circuit signals on said top surface of said outer casing wherein said proximity sensing circuit detects the nearby proximity of metallic objects using one or more coils through the measurement of the inductance and resistance of said one or more coils which is then converted to level of proximity with a digital converter.

The above embodiment can be further modified by defining that an actuator is located on said perimeter surface and connected to said power source.

The above embodiment can be further modified by defining that said power source further comprises: a battery source; an ON/OFF switch; and a voltage regulator.

The above embodiment can be further modified by defining that said controller further comprises: a processor; a clock; RAM; non-volatile RAM; a program; and a calibration table.

The above embodiment can be further modified by defining that said sensing circuit is coupled to each of said one or more coils directly.

The above embodiment can be further modified b defining that said sensing circuit is coupled to each of said one or more coils through multiplexing.

The above embodiment can be further modified by defining that said indicator display is comprised of one or more LEDs.

The above embodiment can be further modified by defining that said one or more LEDs are spaced to correspond to the space of said one or more coils,

The above embodiment can be further modified by defining that said indicator assembly further comprises a connecter coupling said one or more LEDs to said controller.

The above embodiment can be further modified by defining that low friction material is located on said bottom surface.

An alternate embodiment teaches a method of detecting metal fasteners behind drywall using inductance comprising the steps of: obtaining a handheld, portable metal fastener detector comprising: an outer casing having a top surface, a bordering perimeter surface, a gripping end and a sensing end wherein said top surface and bordering perimeter surface defined an enclosed space therein; a sensing PCB surface attached to said bordering perimeter surface thereby defining an enclosing bottom surface; a proximity sensing circuit inside said enclosed space of said outer casing located on said sensing end; a controller coupled to said proximity sensing circuit; a display circuit inside said enclosed space of said outer casing located on said sensing end wherein said display circuit is in communication with said proximity sensing circuit; a power source coupled to said controller and connected to said display circuit; an indicator display that displays said display circuit signals on said top surface of said outer casing wherein said proximity sensing circuit detects the nearby proximity of metallic objects using one or more coils through the measurement of the inductance and resistance of said one or more coils which is then. converted to level of proximity to a digital converter; an actuator located on said perimeter surface and connected to said power source; activating said detector through said actuator; placing said bottom surface of said detector against said drywall or other surface behind which metal objects are to be detected; and moving said detector along said drywall other surface until said indicator display displays said signals.

The above embodiment can be further modified by defining that said power source further comprises: a battery source; an ON/OFF switch; and a voltage regulator.

The above embodiment can be further modified by defining that said controller further comprises: a processor; a clock; RAM; non-volatile RAM; a program; and a calibration table.

The above embodiment can be further modified by defining that said sensing circuit is coupled to each of said one or more coils directly.

The above embodiment can be further modified by defining that said sensing circuit is coupled to each of said one or more coils through multiplexing.

The above embodiment can be further modified by defining that said indicator display is comprised of one or more LEDs.

The above embodiment can be further modified by defining that said one or more LEDs are spaced to correspond to the space of said one or more coils.

The above embodiment can be further modified by defining that said indicator assembly further comprises a connecter coupling said one or more LEDs to said controller.

The above embodiment can be further modified by defining that a low friction, material is located on said bottom surface.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a perspective view of the first embodiment of the instant invention.

FIG. 2 is a block diagram of the functional elements of the instant invention, including the proximity sensing circuit, the controller, the power and the display circuit.

FIG. 3A is a diagram indicating the proximity detection of a metal object accomplished by the instant invention.

FIG. 3B is a diagram indicating the proximity detection of a metal object accomplished by the instant invention using an equivalent circuit from that shown in FIG. 3A.

FIG. 4 is a side view of the instant invention while in use on an examined surface having studs with metal fasteners.

FIG. 4A is a cross sectional view of the instant invention with a block diagram of a sensing circuit projected on the cross-section.

FIG. 5A is a top view illustrating the response of the indicators of the instant invention to the increased level of proximity caused by the detection of a metal fastener.

FIG. 5B is a side view illustrating the response of the indicators of the instant invention to the increased level of proximity caused by the detection of a metal fastener.

FIG. 6 is a close up view of one of the coils of the sensor plate array.

FIG. 7 is a diagram illustrating the response of the metal proximity value when the small metal fastener is relative to each of three LC tank sensors.

FIG. 8 is a flow diagram of the software module of the instant invention.

### DETAILED DESCRIPTION OF A PREFERRED EMBODIMENT

### Number Glossary

10 detector
12 metal fastener/detection object
14 drywall surface
16 stud
18 battery indicator light
20 distance d from metal object to proximity sensor
22 wire harness coupling controller to indicator assembly
24 indicator assembly on outer surface
26 grip handle
28 A/C current
30 power controller
32 power source
34 ON/OFF switch
36 voltage regulator
40 controller
41 processor
42 clock
43 RAM
44 non-volatile RAM
45 program
46 calibration table
50 proximity sensing circuit
51 coil
52 multiplexer
53 inductance to digital converter
54 sensing surface assembly
60 display circuit
62 shift registers
64 LED lights
71 outer plastic casing
72 eddy current
73 power button on outside casing
74 sensor coil's equivalent circuit
75 metal target object's equivalent circuit
76 soft low friction adhesive backed material or felt tape
77 proximity value of coil sensor

Turning to the drawings, the preferred embodiment is illustrated and described by reference characters that denote similar elements throughout the several views of the instant invention.

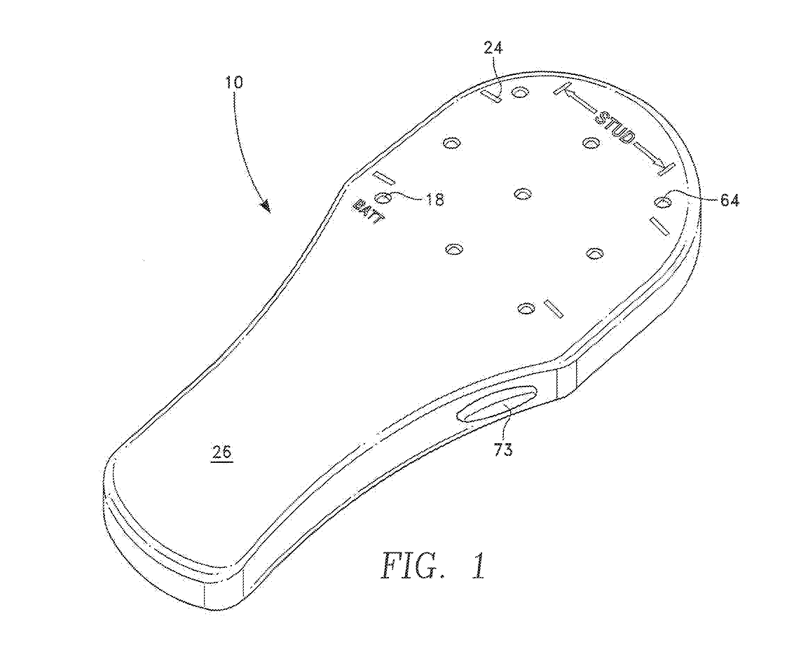

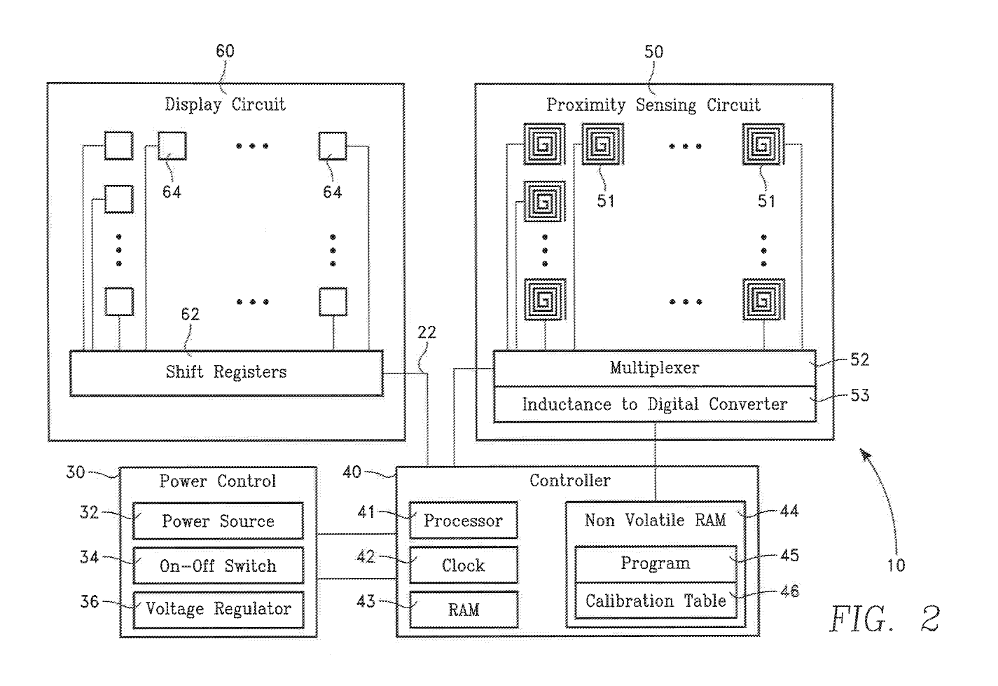

In the preferred embodiment, a detector 10 is an ergonomically designed handheld device as seen in FIG. 1. The detector 10 has its functional portions, i.e., the proximity sensing detector 50 and the indicator assembly 24/display circuit 60 on one end and is designed for comfortable position in the hand on the opposite end with a grip handle 26. On the top of the detector 10 is a battery indicator light, a power switch and an indicator display 24 for indicator LED lights 64. The inner workings of the detector 10 are shown in FIG. 2.

Inside the detector 10 is a power control 30, a controller 40, a proximity sensing circuit 50 and a display circuit 60. The power control 30 includes a battery source 32, typically a battery, an on-off switch 34 and a voltage regulator 36. The power control 30 is connected to the controller 40 which is comprised of a processor 41, a clock 42, RAM 43, non-volatile RAM 44, a program 45 and a calibration table 46. The controller 40 is connecting to the proximity sensing circuit 50.

The sensing circuit 50 is coupled to each coil 51 directly or through analog multiplexing 52. This circuit 50 is configured to measure inductance and resistance of the resonant coil 51 and is converted with an inductance to digital converter 53. The controller 40 is coupled to the sensing circuit 50, being configured to analyze the inductance and resistance measured by the sensing circuit 50.

The sensing surface assembly 54 includes the sensing circuit 50 and a soft low friction adhesive backed material 76, such as felt tape. The felt tape 76 is configured to protect the wall surface 14 while using the detector 10.

A battery source, which can be any battery type as preferred 32 is coupled to the controller 40 for supplying DC power, and. a connector for coupling to the indicator assembly 24 and display circuit 60.

The indicator assembly 24/display circuit 60 is comprised of multiple LEDs 64 located in space proportionally similar to the spacing of the coils 51 previously described. The indicator assembly 24/display circuit 60 is further comprised of a connector for coupling the indicator LED lights 64 to the controller 40, and a button 73 for initiating detection of the metal fasteners 12. The detector 10 indicator 24 is assembled. on a printed circuit board. A wire harness 22 couples the detector assembly 24/proximity sensing circuit 50 to the indicator assembly 24/display circuit 60. (See FIG. 2) Each LED 64 is controlled by a shift register 62 on the indicator assembly 24/display circuit 60, which is controlled through the wire harness 22 by the controller 40 of the detector assembly 24/proximity sensing circuit 50.

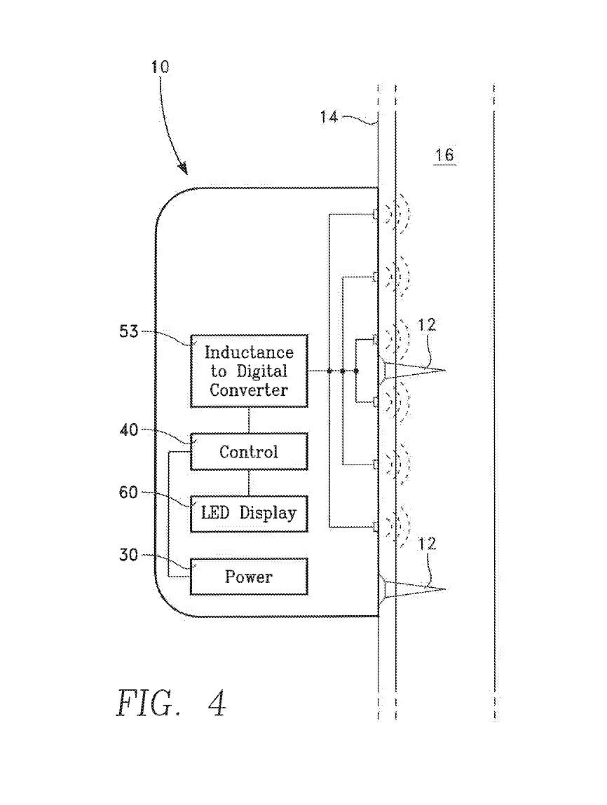

The outer case 71 (FIG. 4A) is comprised of a plastic housing in which the indicator assembly 24 is visible and where the display circuit 60 and proximity sensing circuit 50 are housed. Upon depression of the button 73, the controller 40 is powered and when the sensing thresholds of the controller 40 are reached, the controller 40 signals the shift register 62 of the indicator assembly 24/display circuit 60 to light the associated LED 64.

As shown, the detector 10 includes a proximity sensing circuit 50 that is mounted to the plastic housing 71 by adhesive or non-metallic screw. The plastic housing 71 also encloses the indicator LEDs 64 and the power ON/OFF button 73 near the grip handle 26. The power control 30 is housed inside the plastic housing 71, inside the grip handle 26, which is a power source 32 that can be either a battery or AC adapter circuit. The indicator LEDs 64 are placed equidistant in locations along the top exterior of the top wall of the plastic housing 71. There is one or more LEDs 64, and as shown includes 9 LEDs 64. The indicator could alternatively be an LCD, 8 segments or OLED display. The unit's rough dimensions could be 8 cm×14.5 cm×2.5 cm.

The preferred embodiment of the detector 10 includes the following: a 3V DC power supply 32, an ON/OFF switch 34, a voltage regulator 36, a programmable controller 40, a metal detector sensing circuit 50 and a display circuit 60. The DC power supply 32 can be an alkaline battery, rechargeable battery, or 3V, from an AC/DC power converter plugged into an 110V wall outlet.

The metal proximity sensing circuit 50 provides a means to measure inductance and proximity of a metal object and outputs an electrical signal representative of the inductance and proximity of the metal object.

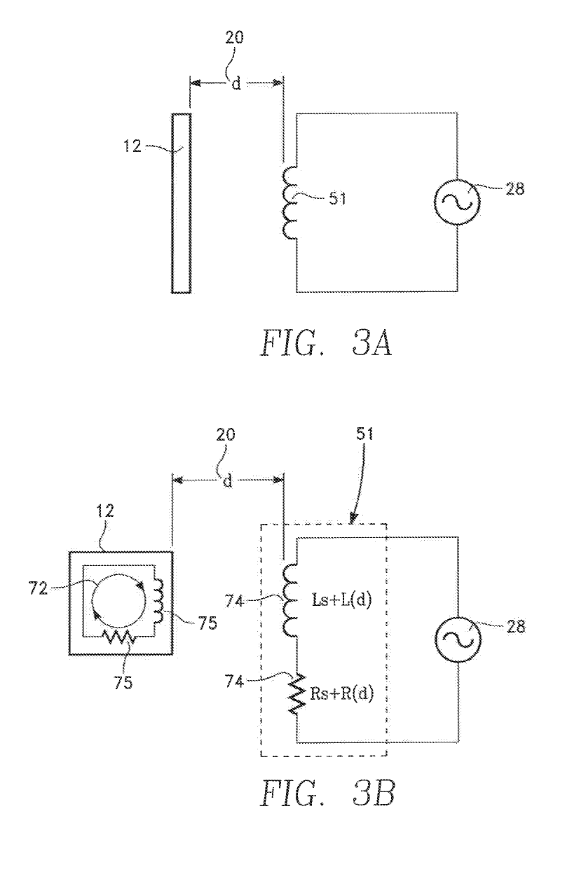

FIGS. 3A-3B illustrate the inductive sensing technology enabling precise proximity and metal measurement. An AC current 28 flowing through a coil 51 will generate an AC magnetic field. If a conductive material such as a metal target 12 is brought into the vicinity of the coil 51, this magnetic field will induce circulating currents (eddy currents) 72 on the surface of the target 12. These eddy currents 72 are a function of the distance, size, and composition of the target 12. These eddy currents 72 then generate their own magnetic field, which opposes the original field generated by the coil 51. Hence, the resistance and inductance of the nearby conductive material shows up as a distant dependent resistive and inductive component in the primary coil.

FIG. 3A shows a simplified circuit model. Eddy currents generated on the surface of the target can be modeled as a transformer as shown in FIG. 3A. The coupling between the primary and secondary coils is a function of the distance 20 and conductor's characteristics.

Both FIGS. 3A and 3B illustrate how inductive sensing works. FIG. 3A illustrates the basic configuration whereas FIG. 3B illustrates an equivalent circuit of 3A. FIG. 3B shows that when the target metal object 12 gets near the AC magnetic field of the sensor's coil 51 it behaves as a second coil/inductor because eddy currents 72 are induced. The equivalent circuit representation of a coil as an inductor plus a series resistor. This is why both coils show both elements in FIG. 3B. When the second coil, i.e., target metal object, gets near the first coil, then the first coil's inductance and resistance changes as a function of distance d 20. In FIG. B. the sensor coil's equivalent circuit is denoted by 74 and the metal target's equivalent circuit is denoted by 75.

In FIG. 3B, the inductance Ls is the coil's inductance, Rs is the coil's parasitic series resistance. The inductance L(d), Which is a function of distance, d 20, is the coupled inductance of the metal target 12. Likewise, R(d) is the parasitic resistance of the eddy currents 72. A plurality of the aforementioned coil sensors 51 is positioned in an array for scanning a surface area of small metal objects. Analog switch multiplexers 52 can be used for sending an AC signal to each coil 51 sequentially in time and sensing for small metal objects 12 in the vicinity of each coil 51.

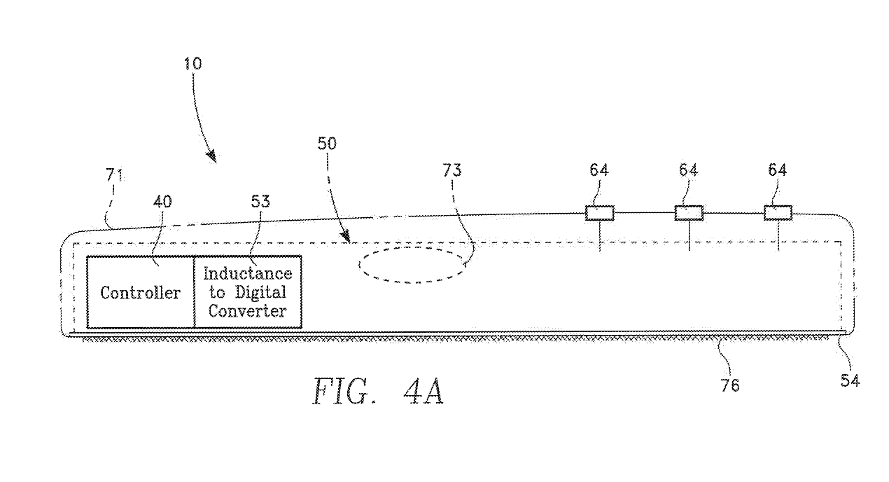

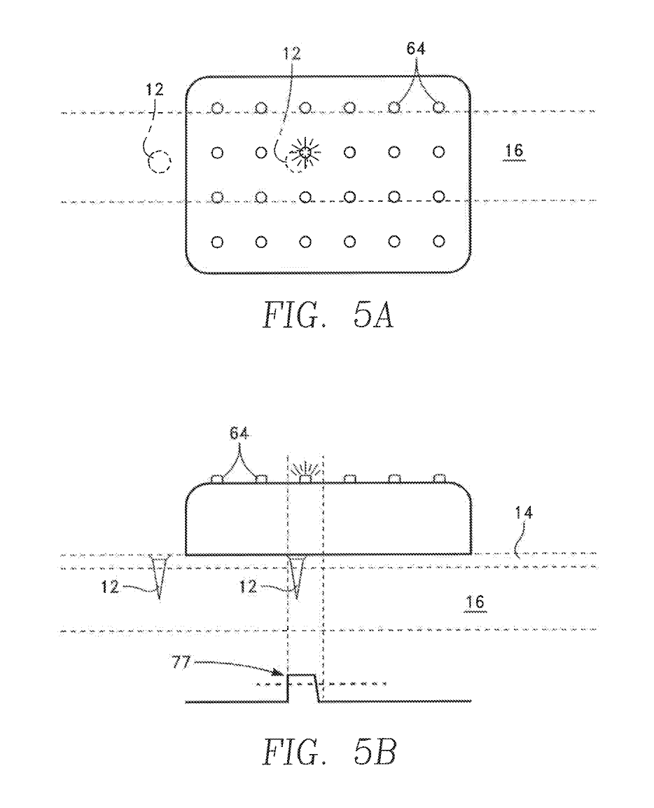

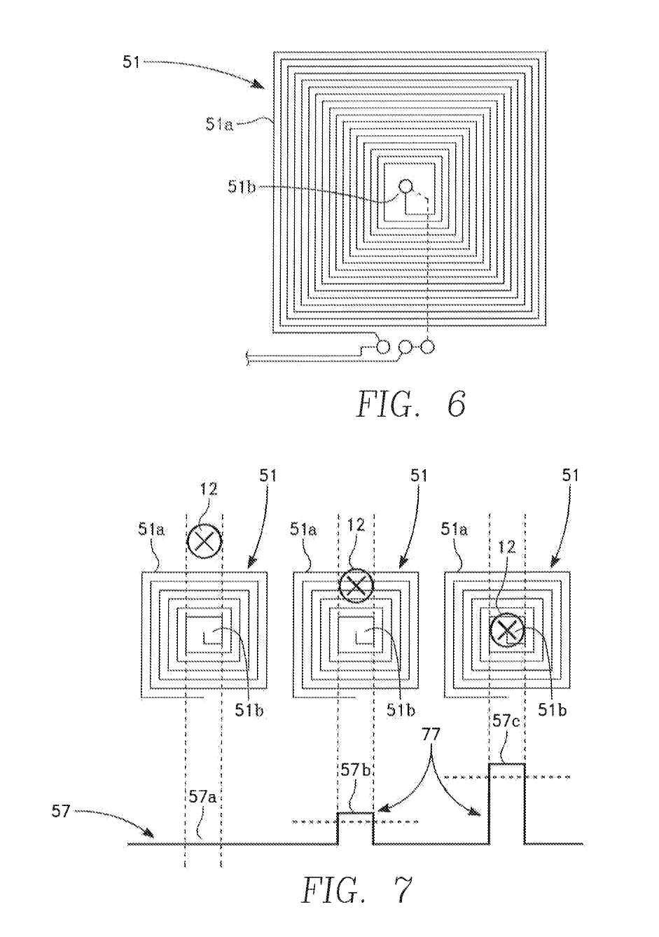

FIGS. 4-4A illustrate how the detector 10 locates wood 16 or metal wall studs by sensing the proximity of the metal drywall fastener 12. The array of sensors 64 through the sensing surface 54 is placed on the surface of the drywall 14, which is typically painted over or has a plaster layer. When the user holds the power button 73 down, the detector 10 begins the algorithm for sensing proximity of small metal objects 12 on the surface of the drywall 14. In most cases, the drywall fastener 12 attaches the drywall 14 to a 2×4 wood stud 16 inside the wall. (See FIG. 5) The detector 10 indicates a metal fastener 12 by lighting the LEDs 64 above the corresponding fastener 12, typically a nail or screw. (See FIG. 5) The stud 16 is located in the same location, vertical or horizontal, as the indicator LEDs 64 are located. When the center of the sensor is located directly over the metal fastener 12 (See FIG. 7), the proximity detection 77 is exponentially greater than if the metal fastener 12 is under the sensor, but not centered. The detector 10 may indicate a coarse location, maybe using a yellow LED, when slightly off center, and indicate a GREEN LED, when directly over the fastener 12. (See FIG. 7).

FIG. 2 illustrates the controller 40 which is a basic microcontroller that can be used for controlling the detector 10. The microcontroller may be chosen from any of a number of available commercial 8-bit microcontroller products that include a CPU processor, NVRAM to store the program and calibration tables. The controller 40 also requires a clock 42 that may be set to run at 8 MHz or 16 MHz, but can vary. RAM 43 is required for doing math functions, real time comparisons, logic and digital communications.

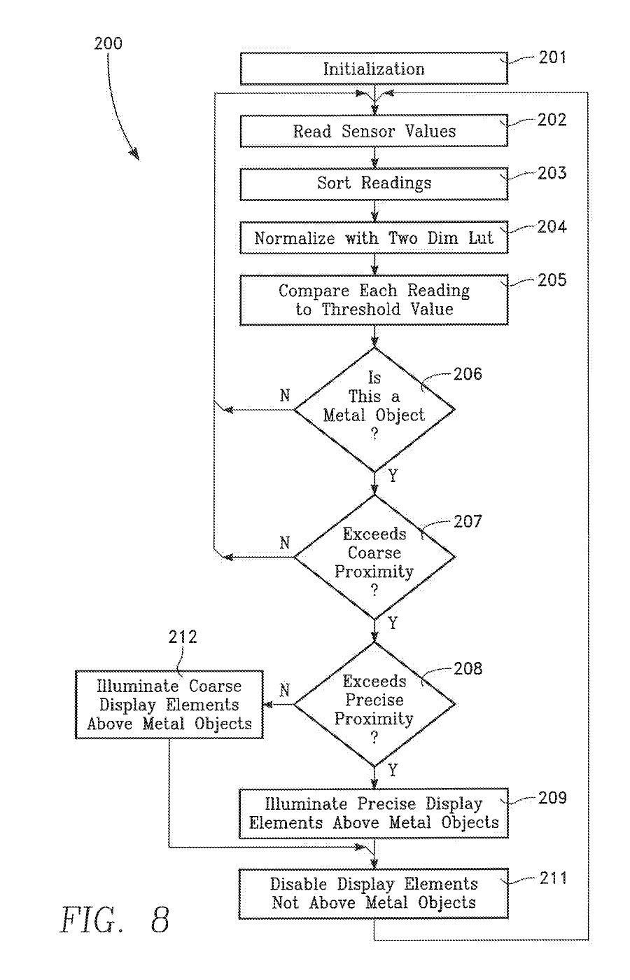

FIG. 8 illustrates a flow diagram of a software module executed by the controller 40 according to the preferred embodiment of the invention. The module 200 begins at step 201 by setting up inputs/outputs (I/O), initializing variables, and clearing counters. Next in step 202, the sensor values are read, which contain the inductance and proximity values of each sensor. This involves managing the switching of the analog multiplexers to read each sensor. Next, in step 203, the individual sensor readings are sorted and normalized according to environmental conditions and factory calibration lookup tables 204, 205. Then in step 206 a comparison is made to a threshold for determining if the object is metallic. If not, there is a return to all reading values. If it is metallic, the routine continues to step 207 where it is determined whether or not the coarse proximity threshold has been exceeded. If not, step of reading sensors 202 repeats. If so, step 208 leads to a precise proximity threshold that is compared to each sensor value. If any sensor reading does not exceed the threshold, the coarse LED is illuminated 212 for sensors, which exceed the course threshold 207. If a sensor reading exceeds the precise threshold the precise LED is illuminated in step 209. In the final step, all the other display elements are disabled 211, and the main loop begins at step 202.

A method of improving the precision of location can be accomplished by making the sensors and LEDs more tightly packed. In this way the invention will display more accurate indication of the metal fastener. Often one wishes to mark the wall in the precise location of the stud. After locating the fastener within the coarse region, the invention can be slid down vertically and the fastener will be indicated using the region of more precision. Another method for indicating more accurate location of the fastener is described in FIG. 7. When the metal fastener is directly under the sensor the reading is exponentially higher than when the faster is off center. The invention can use different colors for displaying better accuracy.

An improvement to the product would be to add a small slide switch or potentiometer knob to allow the user to increase sensitivity of the sensing. This would be especially useful when scanning for studs of plaster walls, or floorboard which is typically a thicker layer. Additionally, the invention can be made more precise by calibrating out environmental conditions such as temperature and humidity, and also battery voltage and power. There can be many methods for calibration, one is to use look up tables in the microcontroller, which are preprogrammed to sense each condition (voltage, humidity, temperature) and correct the reading. Another method is to design an isolated reference sensor in the invention, which can be periodically scanned. The reference results will then be used to correct the actual readings in the program of the microcontroller. Other improvements to the visual indication could be an OLED, LED, or LCD display. Also an app on a mobile phone or table could be connected and provide useful visual identification of metal fastener locations and wood or metal stud locations using a serial data connection, such as USB or Bluetooth. Another improvement to the sensing depth (dipper into the wall) is by adding small ferrite plates or discs to the LC tank. This extends the magnetic field and focuses it towards the small metal fastener.

Any future invention can be built based on the approach of this invention which would utilize larger sensors with deeper metal sensing capability to scan the wall and visually indicate where the pipe and wire conduits reside. This would enable the use of the future invention to have an accurate location of the copper pipe and wiring to avoid when nailing or screwing into the wall stud. Sometimes wiring and piping are located just next to the stud and a user could find that information useful for avoiding costly damage to the interior. Another future invention built on this invention could add the wood sensing capacitive measurement of dielectric loading that today's conventional stud finders utilize to identify and visually indicate where the wooden or metal stud edges begin and end.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A handheld, portable metal fastener detector comprising:
an outer casing having a top surface, a bordering perimeter surface, a gripping end and a sensing end wherein said top surface and bordering perimeter surface defined an enclosed space therein;
a sensing PCB surface attached to said bordering perimeter surface defining an enclosing bottom surface;
a proximity sensing circuit inside said enclosed space of said outer casing located on said sensing end;
a controller coupled to said proximity sensing circuit;
a display circuit inside said enclosed space of said outer casing located on said sensing end wherein, said display circuit is in communication with said proximity sensing circuit;
a power source coupled to said controller and connected to said display circuit;
an indicator display that displays said display circuit signals on said top surface of said outer casing wherein said proximity sensing circuit detects the nearby proximity of metallic objects using one or more coils through the measurement of the inductance and resistance of said one or more coils which is then converted to a level of proximity with a digital converter.

2. The handheld device as defined in claim 1 wherein an actuator is located on said perimeter surface and connected to said power source.

3. The handheld device as defined in claim 1 wherein said power source further comprises:
a battery source;
an ON/OFF switch; and
a voltage regulator.

4. The handheld device as defined in claim 1 wherein said controller further comprises:
a processor;
a clock;
RAM;
non-volatile RAM;
a program; and
a calibration table.

5. The handheld device as defined in claim 1 wherein said sensing circuit is coupled to each of said one or more coils directly.

6. The handheld device as defined in claim 1 wherein said sensing circuit is coupled to each of said one or more coils through multiplexing.

7. The handheld device as defined in claim 1 wherein said indicator display is comprised of one or more LEDs.

8. The handheld device as defined in claim 7 wherein said one or more LEDs are spaced to correspond to the space of said one or more coils.

9. The handheld device as defined in claim 1 wherein said indicator assembly further comprises a connecter coupling said one or more LEDs to said controller.

10. The handheld device as defined in claim 1 wherein a low friction material is located on said bottom surface.

11. A method of detecting metal fasteners behind drywall using inductance comprising the steps of:
obtaining a hand held, portable metal fastener detector comprising:
an outer casing having a top surface, a bordering perimeter surface, a gripping end and a sensing end wherein said top surface and bordering perimeter surface defined an enclosed space therein;
a sensing PCB surface attached to said bordering perimeter surface thereby defining an enclosing bottom surface;
a proximity sensing circuit inside said enclosed space of said outer casing located on said sensing end;
a controller coupled to said proximity sensing circuit;
a display circuit inside said enclosed space of said outer casing located on said sensing end wherein said display circuit is in communication with said proximity sensing circuit;
a power source coupled to said controller and connected to said display circuit;
an indicator display that displays said display circuit signals on said top surface of said outer casing wherein said proximity sensing circuit detects the nearby proximity of metallic objects using one or more coils through the measurement of the inductance and resistance of said one or more coils which is then converted to a level of proximity with a digital converter;
an actuator located on said perimeter surface and connected to said power source;
activating said detector through said actuator;
placing said bottom surface of said detector against said drywall or other surface behind which metal objects are to be detected; and
moving said detector along said drywall or other surface until said indicator display displays said signals.

12. The method as defined in claim 11 wherein said power source further comprises:
a battery source;
an ON/OFF switch; and
a voltage regulator.

13. The method as defined in claim 11 wherein said controller further comprises:
a processor;
a clock;
RAM;
non-volatile RAM;
a program; and
a calibration table.

14. The method. as defined in claim 11 wherein said sensing circuit is coupled to each of said one or more coils directly.

15. The method as defined in claim 11 wherein said sensing circuit is coupled to each of said one or more coils through multiplexing.

16. The method as defined in claim 11 wherein, said indicator display is comprised of one or more LEDs.

17. The method as defined in claim 16 wherein said one or more LEDs are spaced to correspond to the space of said one or more coils.

18. The method as defined in claim 11 wherein said indicator assembly further comprises a connecter coupling said one or more LEDs to said controller.

19. The method as defined in claim 11 wherein a low friction material is located on said bottom surface.
